(19) United States
(12) Patent Application Publication
(10) Pub. No.: US 2022/0403130 A1
(43) Pub. Date: Dec. 22, 2022

(54) Foam Abrasive and Method for Producing Same

(71) Applicant: Robert Bosch GmbH, Stuttgart (DE)

(72) Inventors: Ruben Drost, Dubendorf (CH); Johannes Huber, Konstanz (DE); Steven Lindsay, Belper, Derbyshire (GB)

(21) Appl. No.: 17/756,294

(22) PCT Filed: Nov. 23, 2020
(86) PCT No.: PCT/EP2020/083004

§ 371 Date: May 20, 2022

(30) Foreign Application Priority Data
Nov. 29, 2019 (DE) 10 2019 218 560.6

(51) Int. Cl. C08J 9/36; B24D 11/00; B24D 3/00; C09K 3/14

(52) U.S. Cl. CPC C08J 9/365; B24D 11/001; B24D 3/004; C09K 3/1472; C08J 2207/00; C08J 2375/04; C08J 2205/06; C08J 2205/05

(57) ABSTRACT

A foam abrasive for grinding a workpiece includes a main part made of foam, in particular polyurethane foam, and abrasive grains which are fixed to at least one surface of the foam abrasive via a base binder made of thermoplastic polyurethane. The abrasive grains are covered with a cover binder.

The invention relates to a foam abrasive for the abrasive working of a workpiece, and to a method for producing said abrasive.

### PRIOR ART

Foam abrasives are known in principle from the prior art, as for example from U.S. Pat. No. 4,887,396 A. These abrasive articles have the advantage that in the course of an abrading operation they adapt their shape to the contour of an object to be abraded, with the soft foam main body undergoing elastic deformation. For this reason foam abrasives represent the first choice in abrading operations on nonplanar objects.

Also known is the use of size coats from the abrasive industry, including in particular for foam abrasives. According to foam abrasives known from the prior art, it is known practice to use a size coat in combination with waterborne or solventborne binders.

There is an ongoing need within the abrasives industry to achieve a further increase in the durability of abrasive articles, particularly of foam abrasives, while at the same time reducing environmental burden and production cost/complexity.

### DISCLOSURE OF THE INVENTION

The invention relates to a foam abrasive for the abrasive working of a workpiece, comprising a main body of foam, more particularly of polyurethane foam, and abrasive grains affixed on at least one surface of the foam abrasive by means of a make coat of thermoplastic polyurethane (TPU). It is proposed that the abrasive grains be covered with a size coat.

The foam abrasive is an abrasive article for the abrasive working of an object. This abrasive working may be possible in the form of manual sanding and/or in the form of sanding performed mechanically. The expression “abrasive working” includes polishing. The foam abrasive, more particularly the main body which gives the foam abrasive its essential form, may in principle take different forms—for example as a block, as a disk, as a roller, as a belt, as a strip or the like. It is also conceivable for the foam abrasive to be integrated into a glove in such a way that the foam abrasive forms the glove surface located on the side of the hand inner face and of the finger inner faces. The foam abrasive, moreover, may also be produced for use with sanding machines such as eccentric sanding machines, for example.

The main body of the foam abrasive comprises at least one foam. More particularly, the foam may be porous and/or air-permeable. The foam may also be configured as a closed-cell, open-cell or mixed-cell foam. More particularly the foam is flexible and more particularly elastically deformable. The main body of foam gives the foam abrasive its essential form and specific properties in terms of flexibility and stability, more particularly in terms of elasticity, extensibility, compressibility, shearability, ultimate tensile and tensile strength. These specific properties authoritatively characterize the handling qualities and the properties of the foam abrasive during an abrading operation. In one embodiment of the foam abrasive, the main body may be realized of a polyurethane foam, and more particularly may consist thereof. Polyurethane is suitable advantageously because of good processing qualities in the production method, since polyurethane has advantageous hardness and ultimate tensile strength. In principle, alternatively, the main body may also be realized of ethylene-vinyl acetate copolymer (EVA), polyethylene (PE), polypropylene (PP), acrylonitrile-butadiene rubber (nitrile rubber, AB or NBR), polystyrene (PS), polyurethane (PE) or the like.

The foam abrasive has abrasive grains on at least one surface of the main body. The at least one surface may be selected in particular to be the entire surface of the main body. Alternatively, the at least one surface may also be selected to be a part of the entire surface of the main body. The term “abrasive grain” is intended to denote an element which has a deforming and/or ablative effect on the object to be worked, i.e., a workpiece. An abrasive grain here may be formed more particularly of a mineral and/or ceramic material, such as, for example, of diamond, of corundum, of silicon carbide, of boron nitride or the like. In one exemplary embodiment the abrasive grains are realized by aluminum oxide particles having a particle size of between 7 μm and 300 μm. More particularly, the abrasive grain may have any geometric configuration appearing to a skilled person to be rational. The abrasive grain may be what is called a shaped abrasive grain or a crushed abrasive grain. On the object to be worked, an abrasive grain gives rise to friction and evolution of heat, which exerts a deforming and/or ablative effect on/in the object to be worked.

In the case of the foam abrasive, the abrasive grains adhere on the at least one surface of the main body by means of a make coat of thermoplastic polyurethane (TPU). The make coat firmly bonds the abrasive grains on the main body, more particularly in a desired position and distribution, and affixes them accordingly. The make coat serves further to endow the foam abrasive, on its at least one surface, with specific properties in terms of adhesion, elongation, ultimate tensile and tensile strength, flexibility and stability. The term “make coat of thermoplastic polyurethane” here encompasses all thermoplastic elastomers based on urethane and refers to a solvent-free adhesive. The make coat is a hotmelt adhesive which can be applied and processed without solvent. A “hotmelt adhesive” more particularly here is a solvent-free hot-applied adhesive which is substantially solid at room temperature and in the heated state, in liquefied form, can be applied, more particularly by pouring or spreading, and produces a solid compound again on cooling.

In the case of foam abrasives, typically, edges of the foam abrasive undergo particularly severe stressing during an abrading operation, and so abrasive grains located there are subject to high loads. As a result of these loads, abrasive grains—in some cases together with adjacent foam material of the main body—at the edges are parted particularly quickly from the make coat and are therefore no longer available in the ongoing abrading operation. It is further the case that abrasive grains parted in this way introduce unwanted scratches or grooves into the surface of an object to be abraded, as they are moved in an uncontrolled way between the object and the foam abrasive during the abrading operation. The edge degradation described leads typically to a premature end to the utilization of a foam abrasive, despite the fact that the planar surface regions of the main body would usually still be utilizable for further use in abrading operations.

The basis for the present invention is the finding that, based on the use of the make coat of thermoplastic polyurethane, the covering of the abrasive grains with an additional size coat unexpectedly improves the attachment of the abrasive grains to the main body. Size coats are known from the prior art, as for example from WO 13014116 A1, for coated abrasive articles such as abrasive disks. Experiments, however, show that the combination of the make coat of thermoplastic polyurethane with a size coat additionally affixes the abrasive grains of the foam abrasive in a particularly advantageous way on the main body, allowing the adverse effects identified above to be significantly reduced or entirely avoided. Furthermore, a service life (usage duration) of the foam abrasive can be significantly increased and the overall ablation by the foam abrasive boosted. The surface quality brought about on the worked object can also be advantageously increased.

In one embodiment of the foam abrasive, the size coat is realized as a reactive one-component adhesive. A reactive adhesive is more particularly a binder which by chemical reaction produces an attachment of the binder to an abrasive grain. In one embodiment, for example, the one-component adhesive may be realized as a UV-curing adhesive. More particularly the one-component adhesive may be a hotmelt adhesive. More particularly the hotmelt adhesive is a substance from a list of adhesives which encompasses at least polymers such as polyamides, polyethylene, amorphous poly-alpha-olefins, ethylene-vinyl acetate copolymers, polyester elastomers, polyurethane elastomers, copolyamide elastomers or vinylpyrrolidone-vinyl acetate copolymers, and resins such as rosin, terpenes, hydrocarbon resins, and natural or synthetic waxes. For example, a reactive hotmelt adhesive may first be heated and in the process melted, applied, and then solidify again as it cools. As well as the mechanical binding of the abrasive grains in the context of a force-mediated connection and/or a form-mediated connection, there is also advantageously a chemical attachment through a fusional connection. For example, isocyanate-containing chains provided in the hotmelt adhesive may after processing take up moisture from ambient air within a certain time, typically within days, and may therefore chemically react and crosslink. Accordingly, a reactive binder of this kind cannot be melted again.

In one embodiment of the foam abrasive, the size coat is realized as a two-component adhesive. A two-component adhesive is more particularly a binder which acquires its adhesive properties on the basis of a chemical reaction which is initiated at least partly by mixing of the two components. The two components react with one another, resulting in the desired adhesive properties of the two-component adhesive. In one embodiment, the two-component adhesive is chosen to be a polyurethane-based two-component adhesive. A polyurethane-based two-component adhesive may comprise, for example, isocyanate, polyol (diol, triol, etc.). It would be possible, illustratively, to select a polyurethane-based two-component adhesive from Huntsman (Vitrox ABR 7400) with a mixing ratio of 50 to 50. It has been found that by virtue of its high temperature strength, a polyurethane based two-component adhesive stabilizes the structure on the surface in such a way that the abrasive grains are reliably held on the foam abrasive and affixed even under the influence of elevated forces and/or elevated temperatures of up to 200° C.—as may easily occur in the abrading operation. Additionally, a polyurethane-based two-component adhesive of this kind appears to develop a particularly strong attachment to the make coat of thermoplastic polyurethane, with the attachment exhibiting advantageous elastic properties based on the size coat layer formed. In one embodiment of the foam abrasive, the size coat is realized as an acrylate adhesive, a methacrylate adhesive or an epoxy adhesive or an adhesive based on a radically crosslinking ethylene-vinyl acetate copolymer (EVA).

In one embodiment of the foam abrasive, the size coat has a surface weight of between 10 g/m² and 80 g/m², more particularly between 20 g/m² and 40 g/m², very particularly between 25 g/m² and 35 g/m². The surface weight here may be selected differently as a function of the prevailing size of the abrasive grains. The surface weights proposed allow the realization of an advantageous stabilization of the abrasive grains on the surface of the main body, in conjunction with advantageously thin embodiment of the applied layer of size coat.

In one embodiment of the foam abrasive, the size coat has a Shore D hardness in accordance with DIN 53505 of between 30 and 90, more particularly of between 60 and 80, very particularly between 65 and 75. A Shore D hardness is determined using an indenter in the form of a truncated cone having a spherical tip with a radius of 0.1±0.01 mm and an opening angle of 30±1°. In the SHORE D hardness testing method, in conjunction with a measuring stand, an accessory device is used, to increase the precision, that smoothly presses the test specimen for measurement against the contact surface of the measuring platform with a pressing force of 50±0.5 N. The scale of the Shore D hardness here ranges from 0 Shore (corresponding to a penetration depth of 2.5 mm) to 100 SHORE (corresponding to a penetration depth of 0 mm). The scale value of 0 corresponds to the maximum possible indentation, i.e., the material offers no resistance to the penetration of the indenter. Conversely, the scale value of 100 corresponds to a very high resistance by the material to the penetration, and virtually no indentation is produced. A hardness of the size coat as proposed makes it possible in particular to give an advantageous configuration to the stability of the covering layer that is formed and in which the abrasive grains are embedded and therefore affixed. It is noted that the hardness of the size coat may be determined on an isolated layer of the size coat.

In one embodiment of the foam abrasive the size coat has a tensile strength, more particularly an ultimate tensile strength, of between 5 MPa and 65 MPa, more particularly between 20 MPa and 60 MPa, very particularly between 40 MPa and 55 MPa. The layer of size coat configured with a tensile strength of this kind advantageously has a high stability, and so under actual abrading operation conditions as well it is possible to prevent abrasive grains and also foam material being torn away from the main body. It is noted that the tensile strength, more particularly the ultimate tensile strength, of the size coat may be determined on an isolated layer of the size coat.

In one embodiment of the foam abrasive, the size coat has an elongation at break (strain to failure) of more than 3%, more particularly of more than 10%, very particularly of more than 15%. The elongation at break here characterizes the percentage extension of the size coat (in the form of a layer) before it breaks or ruptures. In this way it is possible advantageously to ensure that the layer of size coat formed on the surface of the main body has a high elasticity, permitting reversible deformation of material to occur even on exposure to strong forces, more particularly shearing forces and/or compressive forces and/or torsional forces, with which abrasive grains and/or foam material can be held securely in/on the main body. It is noted that the elongation at break may typically be determined on an isolated layer of the size coat, with the proposed values relating to results of measurement at 25° C. on a layer of the size coat 2 mm thick.

In another aspect of the invention, a method is proposed for producing the foam abrasive of the invention, the method comprising at least the method steps of:
providing a main body of foam, more particularly of polyurethane foam,
coating the main body on the surface with make coat of thermoplastic polyurethane (TPU),
applying abrasive grains to the surface and affixing them by means of the make coat,
applying size coat, with the size coat covering the abrasive grains and the make coat.

In one embodiment of the method, the size coat is applied by spraying and subsequently cured. In one embodiment of the method, the size coat here (more particularly prior to sprayed application) has a viscosity of between 150 mPa·s and 8000 mPa·s, more particularly between 200 mPa·s and 4000 mPa·s. Alternatively or additionally, the size coat may also be applied in the form of pulverulent, more particularly thermoplastic polyurethane-based, material to the surface of the foam abrasive, and then melted by supply of heat in a subordinate method step. The curing of the size coat may be accomplished by supply of heat or, alternatively or additionally, with chemical induction or induction by UV light. In accordance with the method of the invention, more particularly, the foam abrasive of the invention may be produced rapidly and with few unit operations in an economically advantageous way. The use of a polyurethane-based two-component adhesive makes it possible to achieve particularly short times for the method step of curing under the influence of heat.

It is possible accordingly to specify a foam abrasive and also a method for producing it, with the foam abrasive exhibiting a relatively high ablation rate of material, a relatively long service life, less formation of scratches and grooves on the surface of the object to be abraded, and also relatively strong edges.

### DRAWINGS

The invention is elucidated in more detail in the description below with reference to exemplary embodiments represented in the drawings. The drawings, the description and the claims contain numerous features in combination. The skilled person will expediently also consider the features individually and associate them to form rational further combinations. Identical reference symbols in the figures denote identical elements.

In the drawings

FIG. 1 shows a detail from a schematic sectional representation of one exemplary embodiment of the foam abrasive of the invention;

FIG. 2 shows an exemplary embodiment of a method for producing a foam abrasive of the invention.

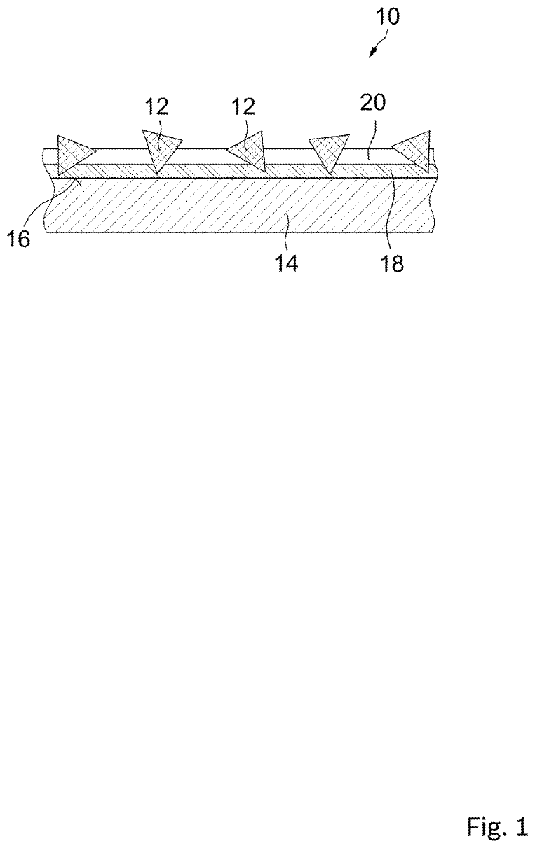

FIG. 1 shows a detail from an illustrative exemplary embodiment of a foam abrasive 10 of the invention with abrasive grains 12 in a schematic sectional representation. In the embodiment represented, the foam abrasive 10 has a main body 14 in the form of a disk, with abrasive grains 12 disposed on the entire surface 16 thereof. The main body 14 has a thickness of 24 mm in cross section. The main body 14 consists of a polyurethane foam having an open-pore structure. The surface of the main body 14 has a roughness of less than 2.0 μm (here not represented more closely in enlarged form). The abrasive grains 12 are affixed on the surface 16 of the main body 14 by means of a make coat 18 of thermoplastic polyurethane (TPU). Additionally, over the resultant layer of make coat 18 and abrasive grains 12, there is an applied layer of size coat 20, which covers the abrasive grains 12. The size coat 20 is realized as a two-component adhesive based on polyurethane. The size coat 20 is applied on the surface 16 of the main body 14, coated with make coat 18, with a surface weight of 30 g/m². Measured on a layer of size coat (not represented in more detail here), the size coat 20 has a hardness of 30 and a tensile strength of 40 MPa. The elongation at break of the size coat 20, measured on a separate 2 mm thick layer of the size coat 20 at 25° C., is 5%.

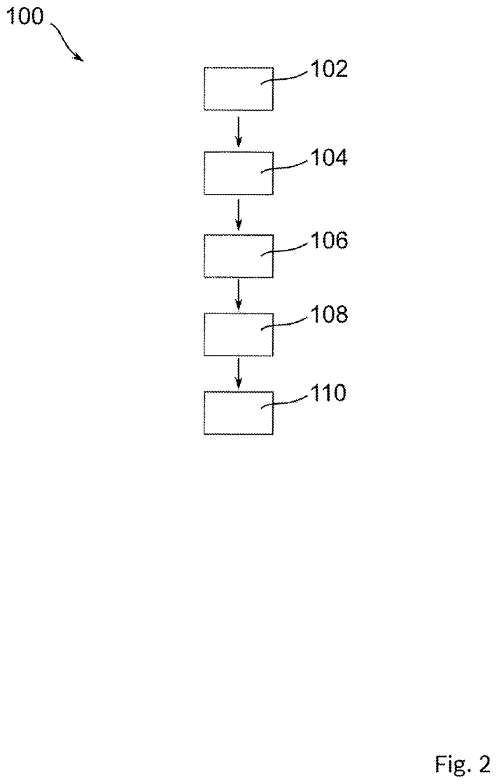

The foam abrasive 10 of the invention may be produced by means of a production method 100 represented in FIG. 2:
method step 102: provision of a main body 14 of foam, more particularly of polyurethane foam,
method step 104: coating of the main body 14 on the surface 16 with make coat 18 of thermoplastic polyurethane (TPU), with for example the parameter settings stated above,
method step 106: application of abrasive grains 12 to the surface 16 and affixing by means of the make coat 18,
method step 108: application—here more particularly sprayed application—of size coat 20, with the size coat 20 prior to spraying having a viscosity of 1000 mPa·s, in such a way that the applied size coat 20 covers the abrasive grains 12 and the make coat 18,
method step 110: curing of the layer of size coat 20 produced, with supply of heat at 170° C. for a duration of 20 seconds.

1. A foam abrasive for abrasive working of a workpiece, comprising:
a main body comprising foam;
abrasive grains affixed on at least one surface of the foam abrasive by a make coat of thermoplastic polyurethane; and
a size coat covering the abrasive grains.

2. The foam abrasive of claim 1, wherein the size coat includes a reactive one-component adhesive.

3. The foam abrasive of claim 1, wherein the size coat includes a two-component adhesive.

4. The foam abrasive of claim 1, wherein the size coat includes an acrylate adhesive, methacrylate adhesive, epoxy adhesive, or an adhesive based on a radical crosslinking ethylene-vinyl acetate copolymer.

5. The foam abrasive of claim 1, wherein the size coat has a surface weight of between 10 g/m² and 80 g/m².

6. The foam abrasive of claim 1, wherein the size coat has a Shore D hardness of between 30 and 90.

7. The foam abrasive of claim 1, wherein the size coat has an ultimate tensile strength of between 5 MPa and 65 MPa.

8. The foam abrasive of claim 1, wherein the size coat has an elongation at break of more than 3%.

9. A method for producing a foam abrasive, comprising:
coating a surface of a main body, which comprises foam, with a make coat of thermoplastic polyurethane;
applying abrasive grains to the surface and affixing the abrasive grains via the make coat;
applying a size coat in such a wav that the size coat covers the abrasive grains and the make coat.

10. The method of claim 9, wherein the applying of the size coat comprises:
spraying the size coat; and
subsequently curing the size coat.

11. The method of claim 9, wherein the size coat has a viscosity (at 25° C.) of between 150 mPa·s and 8000 mPa.

12. The method of claim 11, wherein the viscosity of the size coat is between 200 mPa·s and 4000 mPa s.

13. The method of claim 9, wherein the foam is a polyurethane foam.

14. The foam abrasive of claim 1, wherein the foam is a polyurethane foam.

15. The foam abrasive of claim 5, wherein the surface weight of the size coat is between 25 g/m² and 35 g/m².

16. The foam abrasive of claim 6, wherein the Shore D hardness of the size coat is between 65 and 75.

17. The foam abrasive of claim 7, wherein the ultimate tensile strength of the size coat is between 40 MPa and 55 MPa.

18. The foam abrasive of claim 8, wherein the elongation at break of the size coat is more than 15%.
